(19) United States
(12) Patent Application Publication
(10) Pub. No.: US 2008/0253326 A1
(43) Pub. Date: Oct. 16, 2008

(54) SYNCHRONOUS ADAPTIVE HARQ

(75) Inventor: Aleksandar Damnjanovic, Del Mar, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/101,432

(22) Filed: Apr. 11, 2008

Related U.S. Application Data
(60) Provisional application No. 60/911,579, filed on Apr. 13, 2007.
(60) Provisional application No. 60/912,922, filed on Apr. 19, 2007.
(60) Provisional application No. 60/915,114, filed on May 1, 2007.
(60) Provisional application No. 60/915,645, filed on May 2, 2007.

(51) Int. Cl. H04Q 7/00

(52) U.S. Cl. 370/329

(57) ABSTRACT

Synchronous adaptive HARQ is utilized to mitigate resource fragmentation. Bitmaps are utilized instead of scheduling uplink grants for retransmission. The location of one or more resource blocks can be changed if there is a release of resources in a location of a corresponding resource block. Changing the location of the one or more resource blocks can group the resource blocks toward a first end of a spectrum. The bitmap can include a retransmission offset and a signal that indicates a direction with respect to the retransmission offset. The direction can be a positive direction or a negative direction.

### CROSS-REFERENCE

This application claims the benefit of U.S. Provisional Application Ser. No. 60/911,579, filed Apr. 13, 2007, entitled “A METHOD AND APPARATUS FOR ADAPTIVE HARQ,” U.S., Provisional Application Ser. No. 60/912,922, filed Apr. 19, 2007, entitled “A METHOD AND APPARATUS FOR ADAPTIVE HARQ,” U.S. Provisional Application Ser. No. 60/915,114, filed May 1, 2007, entitled “A METHOD AND APPARATUS FOR ADAPTIVE HARQ,” and U.S. Provisional Application Ser. No. 60/915,645, filed May 2, 2007, entitled “A METHOD AND APPARATUS FOR ADAPTIVE HARQ,” all of which are assigned to the assignee hereof. The entirety of the above noted applications are incorporated herein by reference.

### BACKGROUND

I. Field

The following description relates generally to wireless communication systems and more particularly to scheduling communications in a wireless communication system.

II. Background

Wireless communication systems are widely deployed to provide various types of communication, for example, voice, data, and so on can be provided by such wireless communication systems. A typical wireless communication system, or network, can provide multiple users access to one or more shared resources (e.g., bandwidth, transmit power, . . . ). For example, a system can use a variety of multiple access techniques such as Frequency Division Multiplexing (FDM), Time Division Multiplexing (TDM), Code Division Multiplexing (CDM), Orthogonal Frequency Division Multiplexing (OFDM), and others.

Generally, a wireless multiple-access communication system can simultaneously support communication for multiple access terminals. Each access terminal can communicate with one or more base stations through transmissions on the forward and reverse links. The forward link (or downlink) refers to the communication link from the base stations to the access terminals, and the reverse link (or uplink) refers to the communication link from the access terminals to the base stations. This communication link may be established through a single-in-single-out, multiple-in-single-out, or a multiple-in-multiple-out (MIMO) system.

Wireless communication systems sometimes employ one or more base stations; each base station providing a coverage area. A typical base station can transmit multiple data streams for broadcast, multicast, and/or unicast services, wherein a data stream may be a stream of data that can be of independent reception interest to an access terminal. An access terminal within the coverage area of such base station can be employed to receive one, more than one, or all the data streams carried by a composite stream. Likewise, an access terminal can transmit data to the base station or another access terminal.

An error control method utilized in wireless communication systems can be a synchronous non-adaptive Hybrid Automatic Retransmission Request (HARQ). However, HARQ can cause resource segmentation when more than two access terminals are scheduled in an orthogonal air interface. This resource segmentation can occur on both the uplink and the downlink. Synchronous non-adaptive HARQ on an orthogonal uplink has at least two problems. First, acknowledgement (ACK) to non-acknowledgement (NAGK) errors can lead to collisions because a new access terminal could be scheduled on the same resource block used by a retransmission. Second, early terminations of transmission, with HARQ can lead to resource fragmentations. As a result, uplink performance can be degraded.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects, its sole purpose is to present some concepts of one or more aspects in a simplified form as a prelude to the more detailed description that is presented later.

In accordance with one or more aspects and corresponding disclosure thereof, various aspects are described in connection with synchronous adaptive Hybrid ARQ (HARQ). Bitmaps are utilized instead of scheduling uplink grants for retransmission.

In accordance with an aspect is a method for mitigating resource fragmentation. Method includes deciding if a position of at least one resource block should be changed for an uplink transmission and assigning the at least one resource block to a changed position. Method further includes creating a bitmap to indicate the changed position and transmitting the bitmap in place of an uplink grant.

Another aspect relates to a wireless communications apparatus that includes a memory and a processor. The memory retains instructions related to determining whether a location of one or more resource blocks should be changed and assigning die one or more resource blocks to a changed location. The memory further retains instructions relating to creating a bitmap that provides information relating to the changed location and conveying the bitmap to one or more access terminals. The processor is coupled to the memory and is configured to execute the instructions retained in the memory.

A further aspect relates to a wireless communication apparatus that implements synchronous adaptive HARQ. The wireless communication apparatus includes a means for ascertaining a position of a first resource block and a means for evaluating whether there is a release of resources for at least a second resource block. The wireless communication apparatus also includes a means for changing the position of the first resource block if there is a release of resources and a means for conveying a bitmap that includes the changed position to one or more access terminals.

Still another aspect relates to a computer program product having stored thereon machine-executable instructions for synchronous adaptive HARQ. The instructions include deciding whether there is a release of resources in a location of at least one resource block and reassigning at least a second resource block to the location if there is a release of resources: The instructions also include creating a bitmap that comprises the reassignment and conveying the bitmap to at least one access terminal.

In a wireless communications system, another aspect relates to an apparatus comprising a processor. The processor is configured to decide if a position of at least one resource block should be changed for an uplink transmission and assign the at least one resource block to a changed position. The processor is further configured to create a bitmap to indicate the changed position and transmit the bitmap in place of an uplink grant. The changed position is indicated by a retransmission offset arid a signaling bit.

A related aspect is a method for mitigating resource fragmentation on an uplink. The method includes determining if a bitmap is received in place of an uplink grant. If received, the bitmap is evaluated for a changed position of at least one resource block and the at least one resource block is transmitted at the changed position. In accordance with some aspects, the method includes receiving an uplink grant if a bitmap was not received and evaluating the uplink grant for a New Data Indicator bit. A first set of data or a second set of data can be transmitted based on information included in the New Data Indicator bit. The first set of data is previously transmitted data and the second set of data is new data.

Another aspect relates to a wireless communications apparatus that includes a memory and a processor. The memory retains instructions related to determining if a bitmap is received in place of an uplink grant, evaluating the bitmap for a changed position of at least one resource block, and transmitting the at least one resource block at the changed position. The processor is coupled to the memory and is configured to execute the instructions retained in the memory.

A further aspect relates to a wireless communication apparatus that mitigates resource fragmentation on an uplink: The apparatus includes a means for determining if a bitmap is received in place of an uplink grant and a means for evaluating the bitmap for a changed position of at least one resource block. The apparatus also includes a means for transmitting the at least one resource block at the changed position.

Still another aspect relates to a computer program product having stored thereon machine-executable instructions for synchronous adaptive HARQ. The instructions include determining if a bitmap is received in place of an uplink grant and evaluating the bitmap for a changed position of at least one resource block. The instructions also include transmitting the at least one resource block at the changed position.

In a wireless communications system, another aspect relates to an apparatus comprising a processor. The processor is configured to decide if a bitmap is received in place of an uplink grant and evaluate the bitmap for a changed position of at least one resource block. The processor is further configured to place a “0” or a “1” in the at least one resource block. The “0” indicates a release of resources and the “1” indicates no release of resources. The processor is also configured to transmit the at least one resource block at the changed position.

A related aspect is a method that includes receiving a resource block that includes at least one assigned resource that is set to “1”. The “1” is interpreted as continuing HARQ retransmission. If at least one resource block is set to “1”, there is a continuation of HARQ retransmissions.

To die accomplishment of the foregoing and related ends, the one or more aspects comprise the features hereinafter fully described and particularly pointed out in the claims. The following description and the annexed drawings set forth in detail certain illustrative features of die one or more aspects. These features are indicative, however, of but a few of the various ways in which the principles of the various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 illustrates a multiple access wireless communication system according to one or more aspects.

FIG. 2 illustrates a system that performs scheduling utilizing synchronous adaptive HARQ in a wireless communication environment.

FIG. 3 illustrates a resource segmentation problem that con be mitigated in accordance with the disclosed aspects.

FIG. 4 illustrates a minimized overhead synchronous adaptive HARQ scheme though utilization of a bitmap.

FIG. 5 illustrates a bitmap format that can be utilized with the disclosed aspects.

FIG. 6 illustrates a resource partitioning and bitmap format, which is utilized for Frequency Diverse Scheduling and Frequency Selective Scheduling resource partitioning.

FIG. 7 illustrates a bitmap format with optional offset for persistent resource block offset.

FIG. 8 illustrates a method for mitigating resource fragmentation through utilization of synchronous adaptive HARQ.

FIG. 9 illustrates another method for mitigating resource fragmentation through utilization of synchronous adaptive HARQ.

FIG. 10 illustrates a method for mitigating resource fragmentation on an uplink.

FIG. 11 illustrates a method for transmitting information on an uplink.

FIG. 12 illustrates a system that mitigates resource fragmentation for a communication system in accordance with one or more of the disclosed aspects.

FIG. 13 illustrates a system that facilitates sample rearrangement for a communication system with cyclic extension in accordance with various aspects presented herein.

FIG. 14 illustrates an exemplary wireless communication system.

FIG. 15 illustrates an example system that implements synchronous adaptive HARQ.

FIG. 16 illustrates an example system for mitigating resource fragmentation on an uplink.

### DETAILED DESCRIPTION

Various aspects are now described with reference to the drawings. In the following description, for purposes of explanation, numerous specific details are set forth in order to provide a thorough understanding of one or more aspects, it may be evident, however, that such aspect(s) may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal. A wireless terminal can also be called a system, subscriber unit, subscriber station, mobile station, mobile, mobile device, device remote station, remote terminal, access terminal, user terminal, terminal, wireless communication device, user agent, user device, or user equipment (TIE). A wireless terminal may be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, and/or another processing device for communicating over a wireless system. Moreover, various aspects are described herein in connection with a base station. A base station may be utilized for communicating with wireless terminal(s) and may also he referred to as an access point, Node B, or some other terminology.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

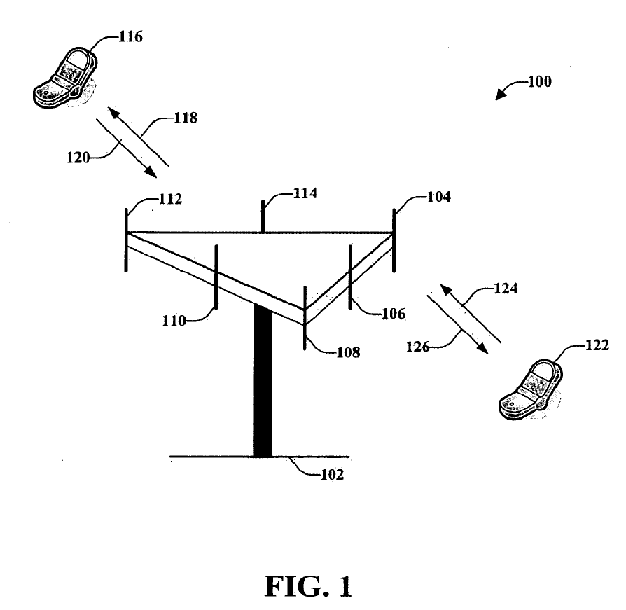

Referring now to FIG. 1, a multiple access wireless communication system 100 according to one or more aspects is illustrated. A wireless communication system 100 can include one or more base stations in contact with one or more user devices. Each base station provides coverage for a plurality of sectors. A three-sector base station 102 includes multiple antenna groups, one including antennas 104 and 106, another including antennas 108 and 110, and a third including antennas 112 and 114. According to the FIG., only two antennas are shown for each antenna group, however, more or fewer antennas may be utilized for each antenna group. Mobile device 116 is in communication with antennas 112 and 114, where antennas 112 and 114 transmit information to mobile device 116 over forward link 120 and receive information from mobile device 116 over reverse link 118. Forward link (or downlink) refers to the communication link from the base stations to mobile devices, and the reverse link (or uplink) refers to the communication link from mobile devices to the base stations. Mobile device 122 is in communication with antennas 104 and 106, where antennas 104 and 106 transmit information to mobile device 122 over forward link 126 and receive information from mobile device 122 over reverse link 124.

Each group of antennas and/or the area in which they are designated to communicate may be referred to as a sector of base station 102. In one or more aspects, antenna groups each are designed to communicate to mobile devices in a sector or the areas covered by base station 102. A base station may be a fixed station used for communicating with the terminals.

Generally, synchronous non-adaptive HARQ can cause resource segmentation when more than two access terminals are scheduled on an orthogonal air interface. This resource segmentation can occur on both the uplink and the downlink. On the downlink, resource segmentation could be addressed with a flexible scheduling grant format, at the expense of downlink control channel overhead. On the uplink, however, due to the single, carrier property of the waveform, the resource segmentation problem cannot be effectively addressed with synchronous non-adaptive HARQ. Therefore, the disclosed aspects utilize synchronous adaptive Hybrid Automatic Retransmission Request (HARQ) to mitigate performance degradation, as will be discussed in further detail below. In accordance with one or more of the disclosed aspects, a bitmap is utilized instead of scheduling uplink grants for retransmission (ReTx).

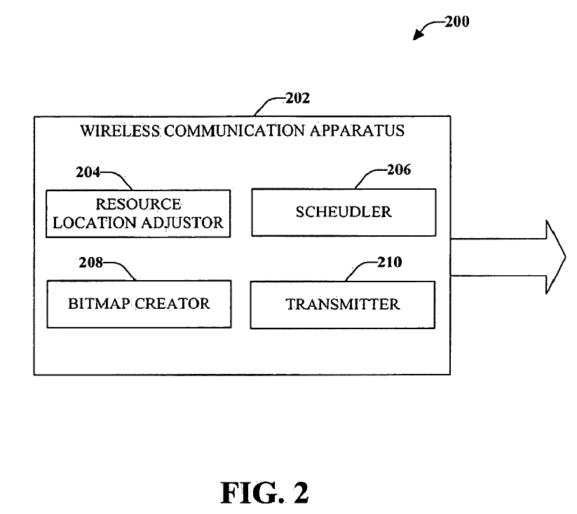

Now turning to FIG. 2, illustrated is a system 200 that performs scheduling utilizing synchronous adaptive HARQ in a wireless communication environment. System 200 includes a wireless communication apparatus 202 that is shown to be transmitting data through a channel. Although depicted as transmitting data, wireless communication apparatus 202 can also receive data through the channel (e.g., wireless communication apparatus 202 can concurrently transmit and receive data, wireless communication apparatus 202 can transmit and receive data at differing times, a combination thereof, and so forth). Wireless communication apparatus 202, for example, can be a base station (e.g., base station 102 of FIG. 1, . . . ), an access terminal (e.g., access terminal 116 of FIG. 1, access terminal 122 of FIG. 1, . . . ), or the like.

A control channel that provides Grants, such as an Access Grant, is sent from a base station. The control channel can accompany a downlink data channel or an uplink data channel. An access terminal cannot transmit on an uplink unless the base station provides a Grant for the access terminal to transmit on the uplink. On the downlink, an access terminal first decodes the control channel to determine if there is data for that access terminal. If there is data for that access terminal, the remainder of the data channel is decoded by the access terminal.

A HARQ is utilized for error control and is when a transmitter continues to transmit a similar “transport block”, which is a packet that is encoded. This transport block might be sent as different redundancy versions that have different encoded bits but refers to the same information bit(s). The periods when the access terminal transmits is determined by the network (e.g., base station), at least on the downlink because the downlink is asynchronous. The uplink is synchronous, however the network (e.g., base station) determines on which resources the access terminal will transmit the data on, which can create excessive overhead in some situations.

System 200 utilizes one control channel to schedule all pending retransmissions. With other control channels, new transmissions are scheduled. The mapping is between resources blocks and the bit position in that control channel. Each access terminal knows at which resource it is transmitting on the uplink and, therefore, knows to which bit it should refer. The access terminal computes on what resource it will transmit again, Which can be based on an implicit rule.

For example, the resources are numbered from 0 to 25 and the access terminal is transmitting on resources 20 through 25. Other access terminals can be transmitting on resources 0 through 19 and, thus, the bit positions in the control channel that corresponds to bits 0 through 19 would be reserved for the other access terminals that transmit on those resources. If there are “0”s on any or all of the resources 0 to 25, it indicates that the transmission was successful and the access terminal assigned to that particular resource waits for a new channel on which to transmit. If the resources from 0 to 25 are all “1”s, it indicates that it was not a successful transmission and the access terminal should retransmit.

Continuing the example, if the resources from 0 to 19 are all “0”s (or a subset thereof are set to “0”), it indicates that those resources are not being utilized by the access terminal to which they were assigned (e.g., the transmission was successful). Thus, the access terminal assigned resources 20 to 25 can re-transmit, not on resources from 20 to 25 but, in accordance with one or more of the disclosed aspects, it can re-transmit on one or more of the freed resources (set to “0”) from 0 to 19. Thus, occupying the resources that are not currently being used. In this manner, the access terminal can determine where to transmit again (HARQ). An option is to transmit on the same resources (20 to 25), however, this can result in segmented resources, which can be mitigated by occupying unutilized resources:

A problem associated with the transmission on the same resources (20 to 25 in the above example) is that the space is segmented. This is because if there are ten access terminals, and five terminate and five do not terminate, it becomes a random distribution of which resources would be occupied and which ones will not be occupied. This limits the scheduler because the schedule has to fill the holes and since the assignment is consecutive in resources (it is a single carrier waveform on uplink), then there may be empty space, which might be needed for oilier access terminals, and so forth.

Thus, system 200 can mitigate the empty spacing by moving the resources in a particular direction, either positive or negative, to compact die resources. An offset can then he applied that puts the compact block of resources in the spectrum. Thus, system 200 employs a mechanism to make the resources compact and provides the ability to apply an offset after which hopping and so forth, can be applied.

Wireless communication apparatus 202 can include a resource location adjuster 204 that can determine if a position of one or more resource blocks should be changed. The position of the resource blocks can be an assigned position (or location), a previously changed position, or combinations thereof. The position can be changed on an uplink transmission in order to mitigate fragmentation of resources and/or to compact the assigned resources. According to some aspects, the location can be changed to group the assigned resources toward a first end of a spectrum, toward a second end or the spectrum, or there between.

The determination by resource location adjuster 204 of whether to change the location can be based upon whether “0”s or “1”s are received in the bitmap in the location of the corresponding resource blocks. The “0”s can indicate termination of HARQ retransmissions of a given transport block. The resource location adjuster 204 can infer, based on the received “0”s that the resources are released and can be utilized by other access terminals, if needed. The “1”s can indicate continuation of HARQ retransmissions and that the resources are not released. In accordance with some aspects, a “0” indicates a positive acknowledgement (ACK) and a “1” indicates a negative acknowledgement (NACK).

A scheduler 206 can assign one or more resource blocks to a changed position (or location) based on the determination made by resource location adjustor 204. The scheduler 206 can assigned the position in order to fill empty space, which can be utilized for other access terminals. Additionally or alternatively, scheduler 206 can assign the one or more resource blocks so that the resource blocks do not collide with resources already assigned.

Based on the location of die resource blocks, bitmap creator 208 can create a bitmap to represent the corresponding location. The changed location can be indicated by a signal, which can be a bit, in the bitmap. The signal (or bit) can indicate die direction in which the location was changed, which can be a positive direction or a negative direction. A transmitter 210 can send the bitmap in place of an uplink grant. If there is no change in position, a bitmap might not be created and/or sent. No bitmap can indicate termination of HARQ retransmissions.

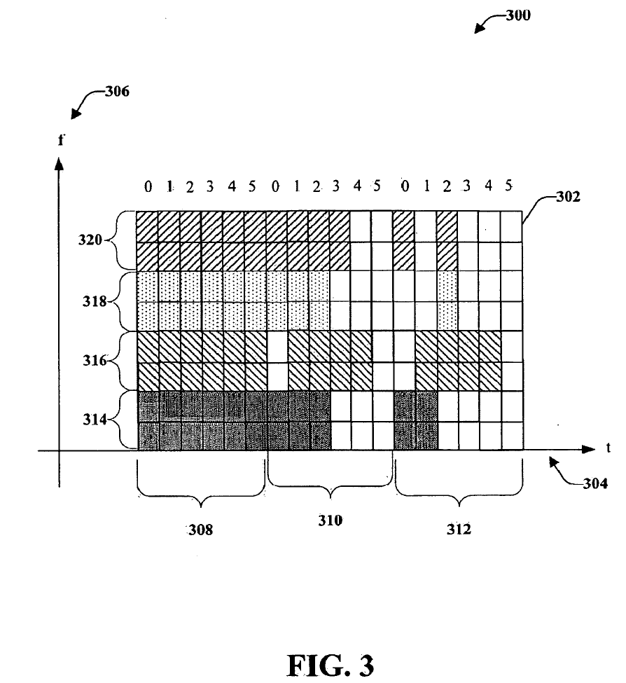

In order to fully appreciate the disclosed aspects, FIG. 3 illustrates a resource segmentation problem 300 that can be mitigated in accordance with the disclosed aspects. Each block, one of which is labeled at 302, indicates a minimum resource block. The horizontal axis 304 represents time and the vertical axis 306 represents frequency. This example represents four access terminals and three transmissions. Each transmission is labeled from 0 through 5, and indicated at 308, 310, and 312. The resources assigned to and utilized by each access terminal are represented by the different shadings, one shading for each access terminal.

New transmissions arc scheduled, as indicated by the shading (different shading for each access terminal) during the first set of transmissions (0 through 5) labeled at 308. As illustrated, a first access terminal is assigned resources at a first end of the spectrum, illustrated at 314, A second access terminal is assigned resources as illustrated at 316 and a third access terminal is assigned resources as illustrated at 318. A forth access terminal is assigned resources at a second end of the spectrum, illustrated at 320.

On an uplink, as illustrated by transmissions 310 and 312, there is a fragmentation of resources. For example, the first access terminal transmits on the uplink transmission 310, on resources blocks 0,1 and 2, but not on resource blocks 3,4, and 5. During uplink transmission 312, first access terminal transmits on resource blocks 0 and 1, but not on resource blocks 2, 3, 4, and 5. The second access terminal transmits during uplink transmission 310 on resource blocks 1, 2, 3, and 4 (but not on resource blocks 0 or 5) and transmits during uplink transmission 312 on resource blocks 1, 2, 3, and 4 (but not on resource blocks 0 or 5). The third access terminal transmits during uplink transmission 310 on resource blocks 0,1, and 2 (but not on 3,4, or 5) and during uplink transmission 312 on resource block 2 (but not 0, 1,3, 4, or 5). The fourth access terminal, in this example, transmits during uplink transmission 310 on resource blocks 0, 1, 2, and 3 (but not 4 or 5) and during uplink transmission 312 on resource blocks 0 and 2 (but not 1, 3, 4, or 5). Thus, the resource blocks or resources that are not utilized by the access terminals result in fragmentation of uplink resources and the scheduler cannot schedule new access terminals over the entire available bandwidth.

The fragmentation problem can be mitigated by implementing synchronous adaptive HARQ, which is similar to asynchronous adaptive HARQ. Asynchronous adaptive HARQ implies that each transmission is scheduled. This solution does hot constitute significant overhead on a downlink because the number of transmissions per transport block is typically small. This is provided for by link adaptation and the almost absence of power limitation.

On an uplink however, power limitation dictates a larger number of transmissions in order to minimize required energy-per-bit-to-noise-plus-interference ratio (Eb/Nt) per information bit. Minimization of required Eb/Nt per information bit leads to minimization of interference to other cells, which helps cell edge access terminals and, therefore, can maximize coverage and capacity. Therefore, it can be costly to schedule each transmission on the uplink.

Scheduling each transmission also serves as an acknowledgment channel. If an access terminal receives a scheduling Grant for retransmissions, the access terminal interprets the Grant as a negative acknowledgement (NACK) and retransmits a predetermined or a signaled redundancy version of the scheduled transport block. Otherwise, if a scheduling Grant is not received, an acknowledgement (ACK) is assumed. Scheduling each transmission is flexible since it allows for adaptation of modulation and coding and resource block size, however, in most situations this is unnecessary.

The disclosed aspects go beyond the above mentioned basic solution and can mitigate downlink control channel overhead. In accordance with some aspects, frequency hopping is possible and can be controlled, such as by a scheduler. In one or more of the disclosed aspects, bitmaps are allocated to resource blocks.

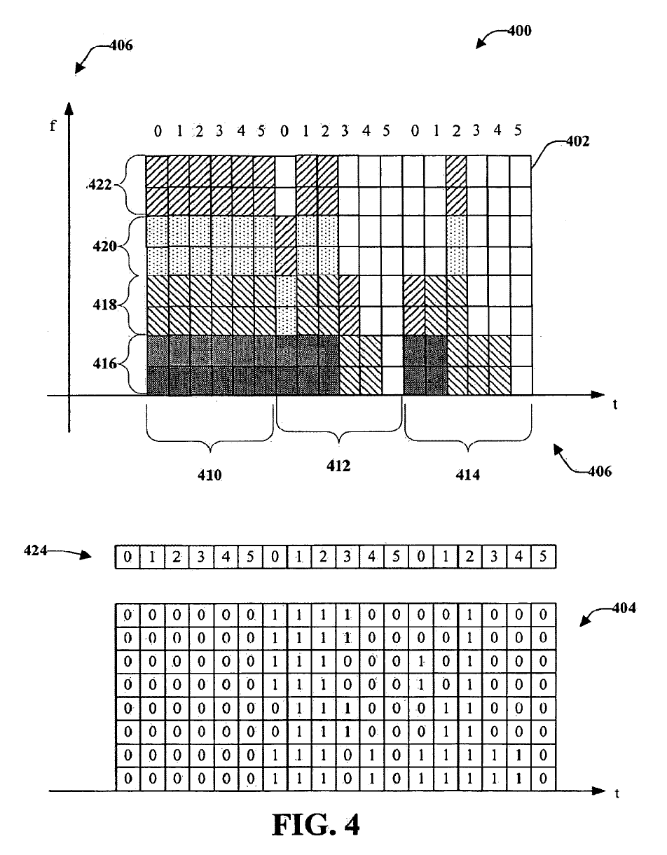

FIG. 4 illustrates a minimized overhead synchronous adaptive HARQ scheme though utilization of a bitmap. In order to mitigate overhead and attempt to prevent resource segmentation, one or more of the disclosed aspects utilize a synchronous adaptive HARQ scheme. A wireless communications apparatus can change the location of assigned resources, illustrated at 400. In accordance with some aspects, the bandwidth can also be adapted.

As illustrated, each resource block, one of which is labeled at 402, is assigned a position in a resource block bitmap 404. The resource block bitmap 404 can be used to schedule retransmissions. In accordance with some aspects, the bitmap 404 can also serve as an acknowledgment channel.

If the bitmap 402 is configured after the access terminal decodes the corresponding bitmap that contains resource blocks on which the access terminal transmitted data on, the access terminal behavior can be summarized in accordance with three different situations, which will now be described. The first situation is if the access terminal did not receive a bitmap, which indicates possible termination of HARQ retransmission.

In accordance with some aspects, if a bitmap is not received, it indicates possible termination of HARQ retransmissions, and an uplink Grant is reviewed to determine if new data or the same data should be transmitted. The uplink Grant can be received in a same sub-frame as the indication of termination of HARQ retransmissions or in a different sub-frame. If a New Data Indicator (NDI) bit in the uplink Grant is set, it indicates that new data should he transmitted. If a New Data Indicator (NDI) bit in the uplink Grant is not, it indicates retransmission of the same data in a different format.

The second situation is if the: access terminal does not receive an uplink scheduling grant and receives “0”s in the bitmap in the location of the corresponding resource blocks. This indicates termination of HARQ retransmissions of a given transport block. In this situation the resources are freed (e.g., release of resources), and can be utilized by other access terminals, if needed.

The third situation is if the access terminal does not receive an uplink scheduling grant and received “1”s in the bitmap in the location of the corresponding resource blocks. This indicates continuation of HARQ retransmissions. In this situation, the access terminal retransmits the corresponding transport block, where resource block location is computed from the bitmap as illustrated in FIG. 4. The resource blocks for retransmissions are grouped towards resources in one edge of the bandwidth or other grouping within the bitmap.

In further detail, in FIG. 4, the horizontal axis indicates time 406 and the vertical axis indicates frequency 408 during a transmission 410. Also illustrated are two uplink transmissions 412 and 414. Four access terminals are assigned resources 0 to 5 as indicated by 416, 418, 420, and 422, similar to the assigned resources of FIG. 3.

To mitigate the fragmentation that occurred on me uplink in the previous figure, adjustments are made to the location of the resources assigned to one or more of the access terminals. It should be noted that the following is for illustration purposes only and other configurations are possible. As illustrated, the first access terminal transmits on the uplink during transmission 412, on resources blocks 0, 1 and 2. Since resources 3, 4 and 5 are freed (not used by the first access terminal), another access terminal can utilize those resources. During uplink transmission 414, first access terminal transmits on the uplink during resource blocks 0 and 1. Resources 2, 3,4, and 5 are freed, and can be utilized by another access terminal. Second access terminal, during first uplink transmission 412, transmits on its own assigned resources, 1 and 2, and on resources 3 and 4, previously assigned to first access terminal. During uplink transmission 414, second access terminal transmits on its own assigned resources 1 and 2 and on resources 2, 3, and 4, which were previously assigned to the first access terminal. Similarly, third access terminal, transmits during uplink transmission 412 on its own resources 1 and 2 and also on resource 0 previously assigned to the second access terminal. During uplink transmission 414, third access terminal transmits on its own assigned resource 2. Lastly, fourth access terminal transmits during uplink transmission 412, on its own assigned resources 1 and 2 and on resource 0 previously assigned to third access terminal and on resource 3, previously assigned to second access terminal. During uplink transmission 414, fourth access terminal transmits on its own assigned resource 2 and on resource 0 previously assigned to the second access terminal.

As illustrated in FIG. 4, the resources are grouped toward a bottom end (e.g., right side) of the spectrum, however, the resources can be grouped in other manners. An interlace for the transmission discussed above is illustrated at 424. In accordance with some aspects, the control channel can be sent two Transmission Time Intervals (TTI) before a traffic channel transmission.

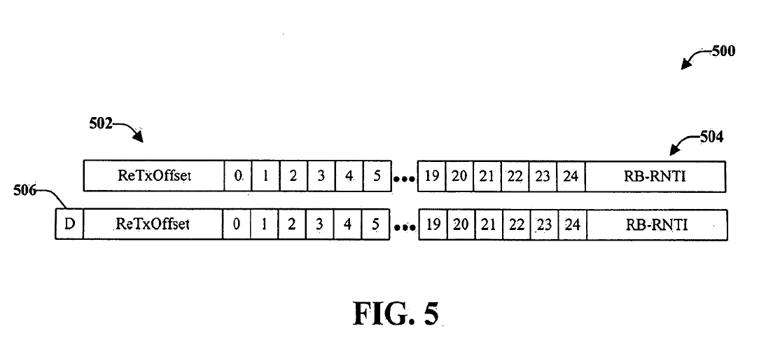

FIG. 5 illustrates a bitmap format 500 that can be utilized with the

disclosed aspects. The starting resource block for the retransmission group, referred to as ReTx offset 502, can be either predetermined (one end of the bandwidth) or signaled in the bitmap itself. In this figure, resource blocks (RB) RNTI 504 is utilized to indicate the bitmap 500. Illustrated are twenty-five resource blocks (labeled 0 through 24), which is an example, and more or fewer resource blocks can be utilized with the disclosed aspects. ReTx offset 502 can be around five bits, however, in accordance with some aspects, it is more (or less) than five bits. In accordance with some aspects, wireless communication apparatus can signal a direction, referred to as “D” bit 506. This bit 506 indicates the direction in which resource blocks are mapped with respect to the ReTx offset 502. The bit 506 can indicate a negative direction or a position direction.

In order to mitigate possible resource segmentation in the case of high erasure rates on this channel, wireless communication apparatus may perform energy detection on the scheduled resources to estimate if some resources are unused.

In accordance with some aspects, the resource block bitmap may be used in place of a downlink acknowledgement channel (DL ACKCH). However, the access terminal may still read a DL ACKOH, which is used to determine if a transport block has been successfully transmitted.

In addition to termination of HARQ retransmissions, “0” in the bitmap can indicate a positive acknowledgment (ACK). A “1” in the bitmap can indicate a negative acknowledgment (NACK). If a bitmap is not received, it could be an indication of a negative acknowledgment (NACK) and the access terminal could retransmit the same data when it subsequently receives an uplink Grant, in accordance with some aspects, not receiving a bitmap indicates a potential positive acknowledgement, the access terminal may transmit a new transport block when it receives a new uplink Grant.

In accordance with some aspects, a bitmap is not received, indicating possible termination of HARQ retransmissions, and an uplink Grant is reviewed to determine if new data or the same data should be transmitted. The uplink Grant can be received in a same sub-frame as the indication of termination of HARQ retransmissions or in a different sub-frame. A New Data Indicator (NDI) bit in the uplink Grant indicates that new data should be transmitted. In accordance with some aspects, the uplink Grant indicates the same data should be transmitted in a different format.

The access terminal may be configured with a maximum number of transmissions for a given transport block. If such limit has been reached and the block has not been successfully decoded, the network has at least two options, which are to negatively acknowledge the transport block or positively acknowledge the transport block, which will now be described.

Negatively acknowledging the transport block can be utilized by placing a “1” in the corresponding bitmap position. In this case, the access terminal continues using the scheduled resources by sending the new transport block with the same modulation and coding. A Radio Link Control (RLC) can be depended upon for error recovery. If the access terminal continues with the same transport block, then MAC layer retransmission can be utilized.

Positively acknowledging the transport block can be utilized by placing a “0” in the corresponding bitmap position. In this case, the access terminal can stop transmitting data and can wait for a new scheduling Grant before transmitting again. For error recovery, the access terminal can depend on RLC and/nr a New Data Indicator (NDI) in the scheduling Grant.

Dynamic network control of the number of retransmissions can be achieved if a maximum number of transmissions are not specified. Instead, the wireless communication apparatus could decide when the access terminal should abandon retransmitting the current transport block by setting “0” in the bitmap.

Interaction with uplink scheduling Grants will now he described. A full uplink scheduling Grant can imply a new transport block transmission or retransmission of the previous transport block. For that purpose, the new data indicator (NDI) bit, as part of uplink Grant can be utilized. In accordance with some aspects, if NDI is not utilized, it can indicate that the access terminal always sends the new data when it receives an uplink Grant.

If a full uplink scheduling Grant is received, the access terminal transmits data in the location indicated in the uplink scheduling grant. If the access terminal receives an uplink Grant, the access terminal transmits the new transport block, if the NDI bit is set. If the access terminal receives an uplink Grant, the access terminal continues with retransmissions of the current transport block if the NDI bit is not set.

The wireless communication apparatus should normally send uplink grants with “0”s in the bitmap, which indicates release of resources. If “1”s are indicated in the bitmap, the wireless communications apparatus should schedule the access terminal in the same resources as the access terminal would compute by using the bitmap only. In accordance with some aspects, the uplink scheduling Grant could be utilized to indicate whether a new transport block is to be transmitted and whether the modulation and coding has changed.

In accordance with some aspects, to address the cell edge problem for delay sensitive services or a control channel overhead problem, persistent resource block assignment may be provided to an access terminal. In order to mitigate resource fragmentation, such assignments should be limited to the edge of the bandwidth. There are at least several options for signaling bandwidth set aside for persistent assignments. One of these options will now be described.

Resources assigned semi-static persistent assignments are mapped to the top (right) part of the bitmap, given that grouping for retransmissions is performed towards the bottom edge of the bandwidth and the bitmap. However, this is only one example of how the resources can be mapped.

If “0”s are received in the bitmap in the location, of the corresponding

resource blocks, it indicates termination of HARQ retransmissions for a given transport block. If “1”s are received in the bitmap in the location of the corresponding resource blocks, it indicates continuation of HARQ retransmissions. If a bitmap is not received, it indicates termination of the transport block transmission.

In accordance with some aspects, to achieve some diversity, per Transmission Time Intervals (TTI) hopping around the middle of the bandwidth could be employed. The hopping applies for all resource blocks and can comprise inverse mapping between the bitmap and the resource blocks.

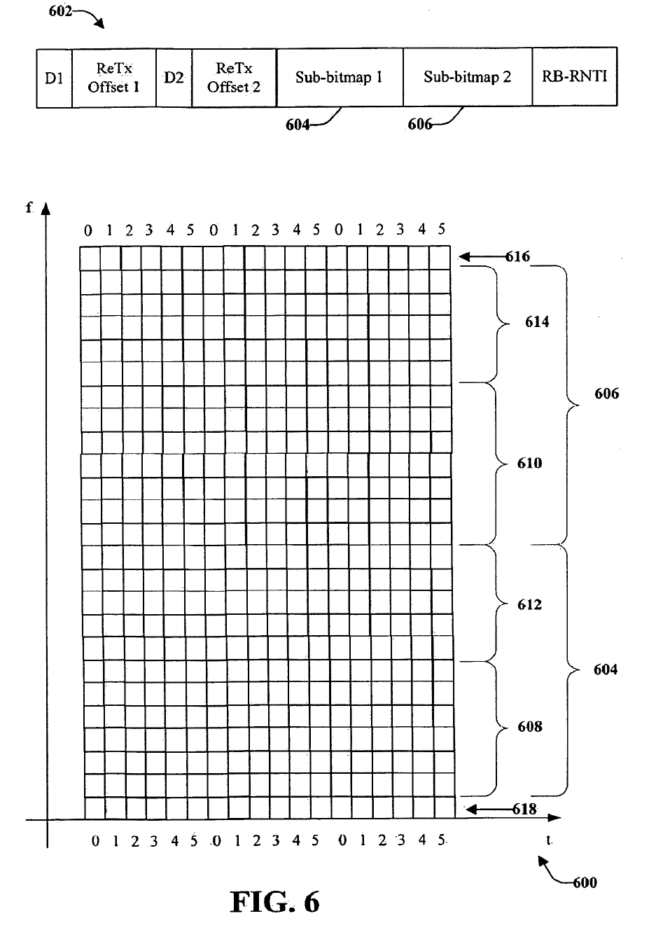

According to some aspects, configuration with frequency selective scheduling can be utilized: FIG. 6 illustrates a resource partitioning 600 and bitmap format 602, which is utilized for Frequency Diverse Scheduling and Frequency Selective Scheduling resource partitioning. Illustrated, are two Sub-bitmaps, which are Sub-bitmap 1 (604) and Sub-bitmap 2 (606). Each Sub-bitmap 604 and 606 includes a pair of frequency diverse scheduling resource blocks 608 and 610 and frequency selective scheduling resource blocks 612 and 614. Illustrated at 616 and 618 are Physical Uplink Control Channels (PUCCH).

The network may partition the resources between the frequency selective scheduling blocks 612 and 614 and the frequency diverse scheduling blocks 608 and 610. The partition can be advertised over the broadcast channel and can be known to all access terminals in the cell or geographic area of the base station.

Potentially corresponding direction bit, D, and ReTx offset are attached to the sub-bitmap 604 and 606. Resource allocation, as described in FIG. 4, applies for each sub-bitmap 604 and. 606. Frequency selective scheduling 612 and 614 can be handled in a similar manner as persistent scheduling: Thus, if “0”s are received in the bitmap in the location of the corresponding resource blocks, it indicates termination of HARQ retransmissions. If “1”s are received in the bitmap in the location of the corresponding resource blocks, it indicates scheduled retransmissions (e.g., continuation of HARQ retransmission). In the case of scheduled retransmissions, the access terminal retransmits the corresponding transport block again using the same resources. If a bitmap is not received, it can indicate termination of the transport block transmission.

In accordance with some aspects, multiple bitmaps could be assigned to an access terminal when there are large bandwidths. Resources could be partitioned statically, similar to the case for frequency selective scheduling, in which case the access terminal needs only to decode a single bitmap. In accordance with some aspects, the access terminal may be required to decode all bitmaps correctly and compute resource assignment based on the content of bitmaps mapped to resources below its own resource.

In some aspects, there is a control channel less (persistent) operation for Voice over Internet Protocol (VoIP). In the case of control channel less mode on an access terminal, first transmissions are scheduled with persistent uplink grants. The access terminal is assigned resources, which it can utilize to transmit first redundancy versions of each transport block. Typically, resources for first transmissions would be periodic, spaced approximately 20 ms apart, in one example. Retransmissions would be scheduled with the bitmap, similar to that illustrated in FIG. 5.

Thus, the difference between the control channel less mode scheduling for VoIP and dynamic scheduling is that in the former case, the scheduler should ensure that retransmissions do not collide with resources already assigned for initial transmissions. In the case of dynamic scheduling, first transmissions are scheduled after retransmissions;

The bitmap approach described to schedule uplink transmissions can be utilized to schedule downlink traffic in a similar manner. However, when scheduling downlink traffic, a downlink HARQ would be synchronous adaptive, instead of asynchronous adaptive.

One or more of the various aspects can support adaptive bandwidth transmission. When an access terminal is scheduled on more than a single resource block, multiple bit locations in the bitmap would be mapped to a given access terminal. Some bandwidth adaptation using the bitmap for retransmissions would be possible to signal in this case. For example, the access terminal is scheduled on four resource blocks. Three resource blocks are NACK's and one resource block is ACK'd. Three resource blocks could signal overall negative acknowledgment (since there is only one ACK'd resource block). However, the access terminal would retransmit on three resource blocks instead of four resource blocks.

As long as more than one resource block is assigned to an access terminal, there is inherent redundancy in the bitmap and some form of bandwidth adjustment for retransmissions is possible. A combination on “0”s and “1”s could indicate an increase in the bandwidth for retransmissions, not just reduction or same bandwidth. However, this type of coding should be known to all access terminals.

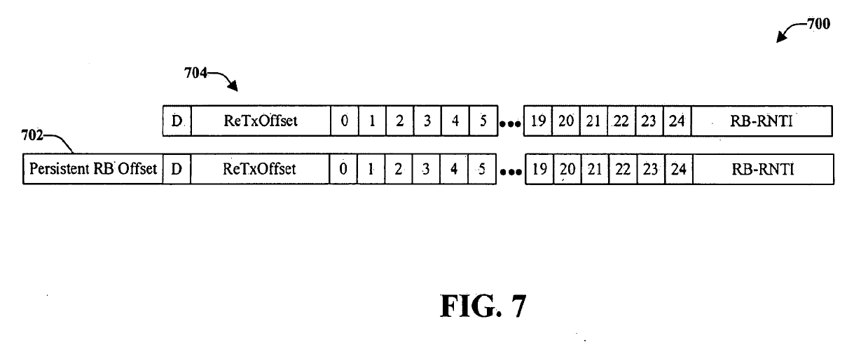

FIG. 7 illustrates a bitmap format 700 with optional offset for persistent resource block offset. This illustrated bitmap 700 is for a 5 MHz system, however, the disclosed aspects are not limited to a 5 MHz system.

The bitmap 700 contains a separate field; referred to as a persistent resource block (RB) offset 702. This field 702 indicates the number of resource blocks with persistent assignment. If there are “0”s received in the bitmap in the location of the corresponding resource blocks, it indicates positive acknowledgment (AGK) and that the resources are freed (e.g., release of resources). If “1”s are received in the bitmap in the location of the corresponding resource blocks, it indicates negative acknowledgment (NACK) and ho corresponding release of resources. The Broadcast Channel indicates the number of resource blocks with persistent assignment.

The Bitmap 700 might not contain a separate field that shows the number of resource blocks with persistent assignment Thus, “0”s can he in the bitmap 700 in the location of the corresponding resource blocks. The number of resource blocks set aside for persistent assignments is accounted for with a ReTx offset, as illustrated at 704. A separate ACKCH. (1 bit−BPSK modulated) can be included to support HARQ.

Smaller bandwidths can have correspondingly smaller bitmaps. Larger bandwidths can utilize either larger bitmaps or the access terminal might decode multiple bitmaps. It is also possible to semi-statically divide a large bandwidth into independent bands (one per bitmap) and allow some fragmentation in between them.

In accordance with some aspects, at least two approaches for uplink Voice Over Internet Protocol (VOIP) can be utilized. These approaches include synchronous adaptive and synchronous group. Synchronous adaptive includes non-scheduled first transmissions and scheduled retransmissions. Synchronous group includes common L1/L2 message, which can allow for adaptiveness.

In accordance with an aspect, synchronous adaptive with group scheduling is utilized for non-scheduled first transmissions and fully scheduled retransmissions. For folly scheduled retransmissions, the group can be scheduled with a resource block bitmap and/or there can be individual uplink grants. Group scheduled with resource block bitmap can mitigate signaling overhead and can serve as a joint acknowledgment channel. Separate DL ACKCH is unnecessary. Individual uplink grants can include optional full flexibility in assigning resources and can overwrite resource block bitmap.

For persistent assignment for first transmissions, in accordance with an aspect, first transmissions are not scheduled. The wireless communication apparatus provides a periodic persistent assignment to a VoIP access terminal.

In accordance with some aspects to provide for fully scheduled uplink transmission and to keep downlink overheard bounded, a resource block bitmap can be utilized, where each minimum resource block is mapped to a position in a resource block bitmap. The resource block bitmap could be thought of as a L1/L2 control channel that is used to schedule a group of access terminals. In addition to scheduling retransmissions, the resource block bitmap could also serve as an acknowledgment channel and separate DL ACKCH is unnecessary.

In the absence of a regular uplink grant, the access terminal interprets the bitmap in the following way. Received “0”s; indicate termination of HARQ retransmissions for a given transport block (Positive ACK). Received “1”s indicate continuation of HARQ retransmissions for a given transport block (Negative ACK). Not receiving a bitmap is interpreted by access terminal as termination of HARQ retransmission. This can be interpreted as a Negative ACK. The access terminal could repeat HARQ process for mat transport block. The access terminal may then request additional resources to prevent queue build up.

In the absence of a regular uplink grant, after transmitting at time starting at resource block location k, the access terminal computes the location for scheduled resource blocks at time t+h for retransmission, denoted as RB(t+n), as:

RB(t+n)=Σ^{k-1}_{q-0}Bitmap(t,i)+ReTxOffset

where Bitmap(t,i) indicates the value of the bitmap for the corresponding transmission at time t for the resource block location i, denotes as RB(t)=i. The wireless communication apparatus B could change the location of assigned resources with a RetRxoffset field.

Individual uplink grants can be utilized by wireless communication apparatus if full flexibility for uplink scheduling is desired. In the presence of a regular (individual) uplink grant, the access terminal interprets the bitmap and uplink grant as follows. An uplink grant indicates scheduled retransmission where first transmissions are persistently scheduled. The uplink grant can be interpreted as a Negative ACK. In accordance with some aspects, the uplink grants takes precedence over HARQ feedback, where the bitmap can represent HARQ feedback. The corresponding field of the resource block bitmap should be set to “0”s indicating to an access terminal that a given transport block is not scheduled for retransmissions with the resource block bitmap.

In accordance with some aspects, adaptive bandwidth control with resource block bitmap is utilized; If the access terminal is assigned more than a single minimum resource block, more than one bit of the resource block bitmap is mapped to an access terminal. Redundant bits in the resource block bitmap could be used to adapt transmission bandwidth: for the retransmissions. For example, if N resource blocks are assigned to ah access terminal for the first transmission or a retransmission, bits are assigned in resource bitmap. If only a single bit is set to 1, it could indicate continuation of HARQ retransmission. The remaining N−1 bits could be utilized to adjust the bandwidth (assume the same MCS) for retransmissions. As an example, each “1” in the bitmap corresponds to each minimum resource block scheduled.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated stales or events, such as in a state diagram.

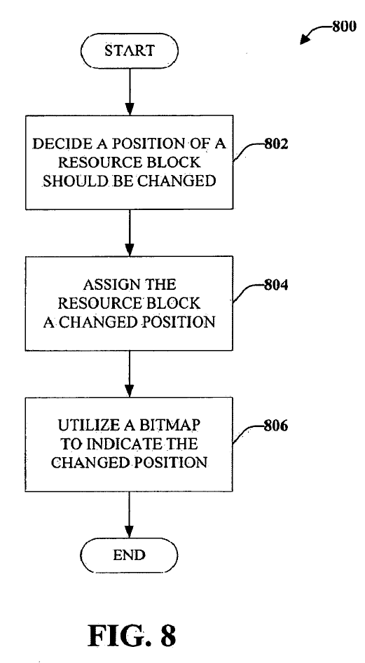

FIG. 8 illustrates a method 800 for mitigating resource fragmentation through utilization of synchronous adaptive HARQ. Method 800 starts, at 802, where a decision is made whether a position of one or more resource blocks should be changed. The resource block position can be an assigned resource position (e.g., assigned resources), a previously changed position (in accordance with die various aspects disclosed herein or through other means); or combinations thereof.

If it is decided that the position should be changed, method 800 continues, at 804, when the at least one resource block is assigned to the changed position. This changed position can be indicated in a bitmap. In accordance with some aspects, assigning the one or more resource blocks to the changed position can include compacting assigned resources included in the uplink transmission. According to some aspects, assigning the one or more resource block to the changed position can include grouping assigned resources toward a first end of a spectrum.

The bitmap is utilized, at 806, to indicate the changed position. In accordance with some aspects, a bit or signal can be included in the bitmap that indicates a direction in which the position of the one or more resource blocks were changed. The direction can be a positive direction or a negative direction. According to some aspects, there is no bitmap transmitted if it is decided that the position of one or more resource blocks should not be changed for the uplink transmission.

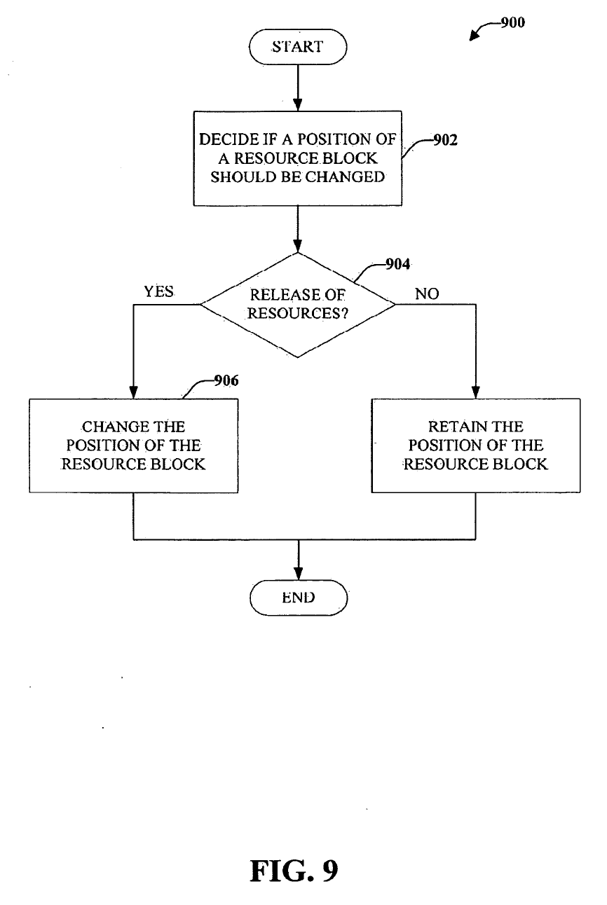

FIG. 9 illustrates another method 900 for mitigating resource fragmentation through utilization of synchronous adaptive HARQ. Method 900 can be utilized to determine whether one or more resource locations should be changed for an uplink transmission.

Method 900 starts, at 902, where a decision is made whether a position of a resource block should be changed. This decision can be made by determining, at 904, if there is a release of resources in a location of a corresponding resource block. A release of resources can be indicated by a “0” and no release of resources can be indicated by a “1”. In accordance with some aspects, an NDI can indicate whether a new transport block will be transmitted or if the existing transport block will be retransmitted. In accordance with some aspects, the “0” indicates a positive acknowledgement (ACK) and the “1” indicates a negative acknowledgement (NACK).

If there is a release of resources (“YES”), method continues, at 906, where the position of one or more resource blocks is changed. The changed position can be indicated in a bitmap, as discussed above. If there is no release of resources (“NO”), method continues, at 908, when the position of the resource block is not changed but retained.

In accordance with some aspects, deciding if: the position of the at least one resource block should be changed for the uplink transmission includes determining if a location of a corresponding resource block includes a “0” or a “1”. The “0” indicates termination of HARQ retransmissions and the “1” indicates continuing HARQ retransmissions. For example, there are four resource blocks and two of the resource blocks are set to “0” and two resource blocks are set to “1”. HARQ retransmission is continuing HARQ retransmissions on two resource blocks.

According to some aspects, there is no bitmap transmitted if it is decided that the position of the least one resource block should not be changed for the uplink transmission. Not transmitting a bitmap indicates termination of HARQ retransmissions.

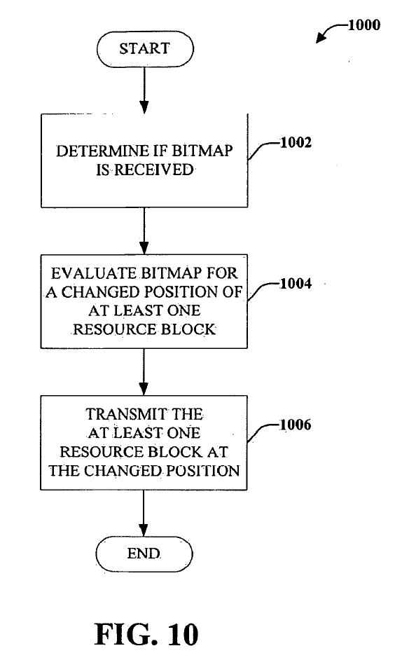

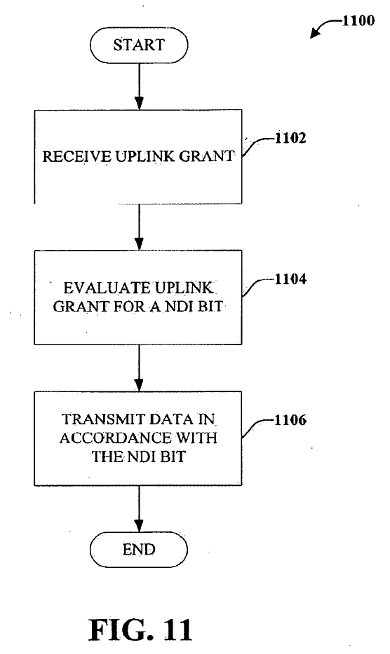

FIG. 10 illustrates a method 1000 for mitigating resource fragmentation on an uplink. Method 1000 starts, at 1002, when a determination is made that a bitmap is received in place of an uplink grant. The bitmap can indicate continuation of HARQ resources or termination of HARQ resources. In accordance with some aspects, a bitmap is not received, which will be discussed with reference to FIG. 11.

Method 1000 continues, at 1004, when the bitmap is evaluated for a. changed position of one or more resource blocks. The evaluation can include reviewing a bit in the bitmap, referred to as a “D” bit. The “D” bit can indicate a direction in which a position of the one or more resource blocks were changed. This direction can be a positive direction or a negative direction. In accordance with some aspects, the direction can be chosen to assign resources toward a first end of a spectrum. The one or more resource blocks can be changed if previously assigned resources are no longer occupying the positions of the one or more resource blocks.

At 1006, the at least one resource block is transmitted at the changed position. In accordance with some aspects, a “0” or a “1” can be placed in one or more of the resource blocks. The “0” can indicate a release of resources and the “1” can indicate no release of resources. In accordance with some aspects, the “0” indicates a positive acknowledgement and the “1 ” indicates a negative acknowledgement.

FIG. 11 illustrates a method for transmitting information on an uplink. In accordance with some aspects, a bitmap might not be received, however, an indication of termination of HARQ retransmissions might be received. At 1102, an uplink grant is received, not a bitmap. The uplink grant can be received at substantially the same time as the termination of HARQ retransmissions indication is received or at a different time.

At 1104, the uplink grant is evaluated for a New Data Indicator (NDI) bit. The NDI bit can be set if new data is to be transmitted. If the NDI bit is not set, it indicates retransmission of old data in a different format. Thus, either the new data or the previously transmitted data is transmitted on the uplink. Thus, depending on whether the NDI bit is set or not set, one of two sets of data can be transmitted (e.g., new data or existing data).

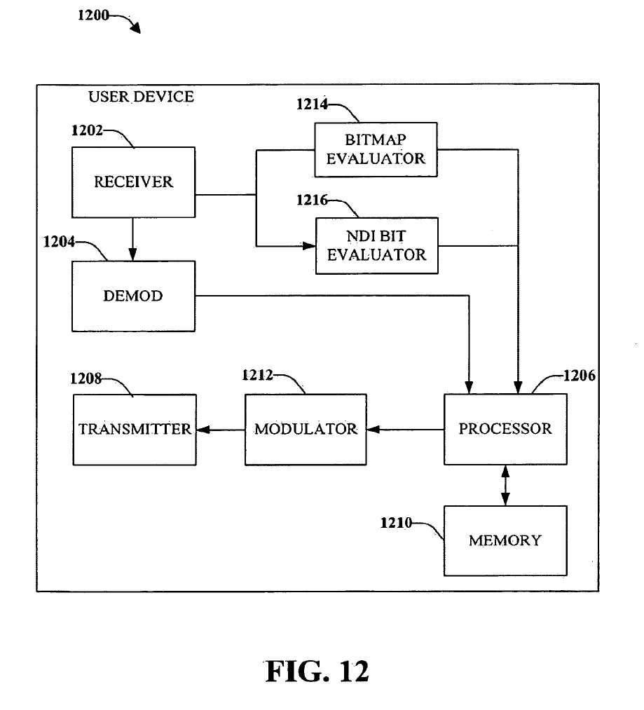

With reference now to FIG. 12, illustrated is a system 1200 that mitigates resource fragmentation for a communication system in accordance with one or more of the disclosed aspects. System 1200 can reside in a user device. System 1200 comprises a receiver 1202 that can receive a signal from, for example, a receiver antenna. The receiver 1202 can perform typical actions thereon, such as filtering, amplifying, downconverting, etc. the received signal. The receiver 1202 can also digitize the conditioned signal to obtain samples. A demodulator 1204 can obtain received symbols for each symbol period, as well as provide received symbols to a processor 1206.

Processor 1206 can be a processor dedicated to analyzing information received by receiver component 1202 and/or generating information for transmission by a transmitter 1208. In addition or alternatively, processor 1206 can control one or more components of user device 1200, analyze information received by receiver 1202, generate information for transmission by transmitter 1208, and/or control one or more components of user device 1200. Processor 1206 may include a controller component capable of coordinating communications with additional user devices.

User device 1200 can additionally comprise memory 1208 operatively coupled to processor 1206 and that can store information related to coordinating communications and any other suitable information. Memory 1210 can additionally store protocols associated with synchronous adaptive HARQ. It will be appreciated thai the data store (e.g., memories) components described herein can be either volatile memory or nonvolatile memory, or can include both volatile and nonvolatile memory. By way of illustration, and not limitation, nonvolatile memory can include read only memory (ROM), programmable, ROM (PROM), electrically programmable ROM (EPROM), electrically erasable ROM (EEPROM), or flash memory. Volatile memory can include, random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1208 of the subject systems and/or methods is intended to comprise, without being limited to, these and any other suitable types of memory. User device 1200 can further comprise a symbol modulator 1212 and a transmitter 1208 that transmits the modulated signal.

Receiver 1202 is further operatively coupled to a bitmap evaluator 1214 that evaluates a bitmap, which was received at receiver 1202, to determine if a location of one or more resource blocks was changed. The change can indicate that resources, previously, assigned to that resource block are freed. If the location of one or more resource blocks was changed, on an uplink, transmitter 1208 sends information in the location of the changed resources block.

Additionally, receiver 1202 can be operatively coupled to a New Data Indicator (NDI) bit evaluator 1206. The NDI bit can be received, at receiver 1202, in an uplink grant. The uplink grant can be received at substantially the same time as an indication of termination of HARQ retransmissions or at a different time. The NDI bit evaluator 1216 can determine if the NDI bet is set or is not set. If the NDI bit is not set, it can indicate that a first set of data (e.g., previously transmitted data) should be transmitted in a different format on the uplink. If the NDI bet is set, it can indicate that a second set of data (eg., new data) should be transmitted on the uplink.

In accordance with some aspects, user device 1200 receives a resource block that includes at least one assigned resource that is set to “1”. The “1” is interpreted as continuing HARQ retransmission. If there is at least one assigned resource set to “1”, it indicates a continuation of HARQ retransmission. An uplink grant that includes a New Data Indicator (NDI) bit can be received and a determination can be made whether the NDI bit is set or is not set. A current set of data can be transmitted on a different resource if the NOT bit is not set to a new set of data can be transmitted if the NDI bit is set.

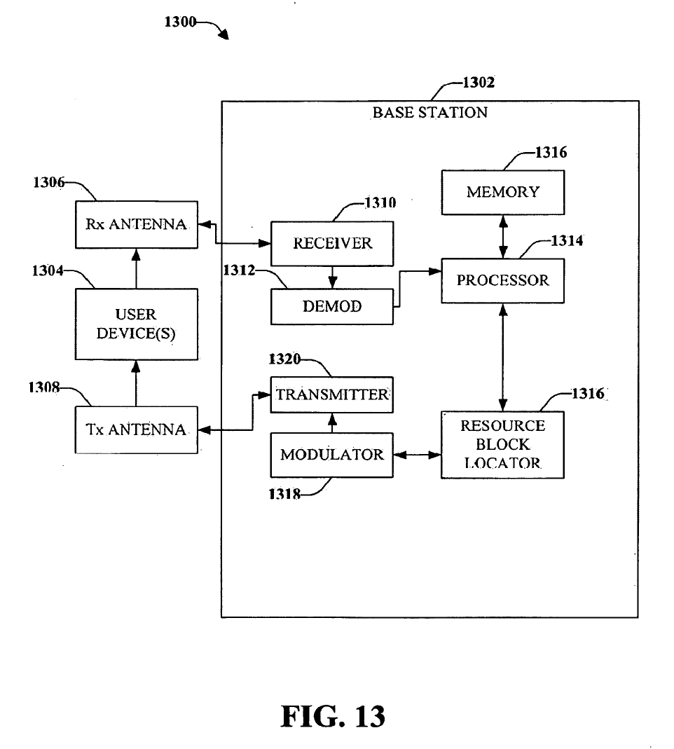

FIG. 13 is an illustration of a system 1300 that facilitates sample rearrangement for a communication system with cyclic extension in accordance with various aspects presented herein. System 1300 comprises a base station or access point 1302. As illustrated, base station 1302 receives signal(s) from one or more user devices 1304 by a receive antenna 1306; and transmits to the one or more user devices 1304 through a transmit antenna 1308.

Base station 1302 comprises a receiver 1310 that receives information from receive antenna 1306 and is operatively associated with a demodulator 1312 that demodulates received information. Demodulated symbols are analyzed by a processor 1314 that is coupled to a memory 1316 that stores information related to synchronous adaptive HARQ. A modulator 1318 can multiplex the signal for transmission by a transmitter 1320 through transmit antenna 1308 to user devices 1304.

Processor 1314 is further coupled to a resource block locator 1316. Receiver block locator 1316 can be configured to change a location of at least one resource block for ah uplink transmission. The determination can be made if there wa$ an indication of a release of resources received in a location of a corresponding resource block. The indication can be received by receiver 1310. If there is an indication of a release of resources, resource block location 1316 changes the location and a bitmap is created to indicate the changed location. The bitmap is transmitted to one or more access terminals by transmitter 1320.

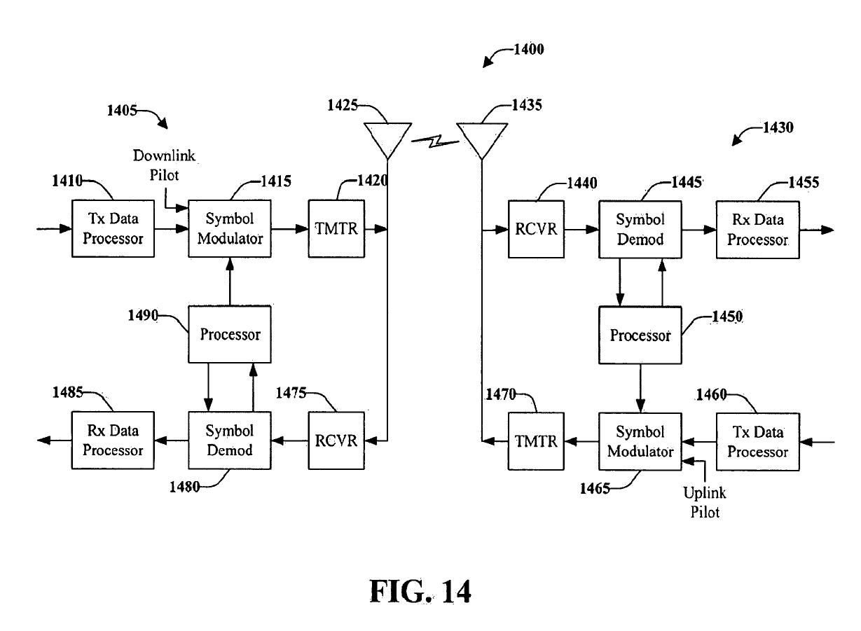

FIG. 14 illustrates an exemplary wireless communication system 1400. Wireless communication system 1400 depicts one base, station and one terminal for sake of brevity. However, it is to be appreciated that system 1400 can include more than one base station or access point and/or more than one terminal or user device, wherein additional base stations and/or terminals can be substantially similar or different from the exemplary base station and terminal described below. In addition, it is to be appreciated that the base station and/or the terminal can employ the systems and/or methods described herein to facilitate wireless communication there between.

Referring now to FIG. 14, on a downlink, at access point 1405, a transmit (TX) data processor 1410 receives, formats, codes, interleaves, and modulates (or symbol maps) traffic data and provides modulation symbols (“data symbols”). A symbol modulator 1415 receives and processes the data symbols and pilot symbols and provides a stream of symbols. A symbol modulator 1415 multiplexes data and pilot symbols and obtains a set of N transmit symbols. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiplexed: (TDM), frequency division multiplexed (FDM), or code division multiplexed (CDM).

A transmitter unit (TMTR) 1420 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 1425 to the terminals. At terminal 1430, an antenna 1435 receives the downlink signal and provides a received signal to a receiver unit (RGVR) 1440. Receiver unit 1440 conditions (e.g., filters, amplifies, and frequency downconverts) the received signal and digitizes the conditioned signal to obtain samples. A symbol demodulator 1445 obtains N received symbols arid provides received pilot symbols to a processor 1450 for channel estimation. Symbol demodulator 1445 further receives a frequency response estimate for the downlink from processor 1450, performs data demodulation on the received data symbols to obtain data symbol estimates (which are estimates of the transmitted data symbols), and provides the data symbol estimates to an RX data processor 1455, which demodulates (i.e., symbol demaps), deinterleaves, and decodes the data symbol estimates to recover the transmitted traffic data. The processing by symbol demodulator 1445 and RX data processor 1455 is complementary to the processing by symbol modulator 1415 and TX data processor 1410, respectively, at access point 1405.

On the uplink, a TX data processor 1460 processes traffic data and provides data symbols. A symbol modulator 1465 receives and multiplexes the data symbols with pilot symbols, performs modulation, and provides a stream of symbols. A transmitter unit 1470 then receives and processes the stream of symbols to generate an uplink signal, which is transmitted by the antenna 1435 to the access point 1405.

At access point 1405, the uplink signal from terminal 1430 is received by the antenna 1425 and processed by a receiver unit 1475 to obtain samples. A symbol demodulator 1480 then processes the samples and provides received pilot symbols and data symbol estimates for the uplink. An RX data processor 1485 processes the data symbol estimates to recover the traffic data transmitted by terminal 1430. A processor 1490 performs channel estimation for each active terminal transmitting on the uplink.

Processors 1490 and 1450 direct (e.g., control, coordinate, manage, . . . ) operation at access point 1405 and terminal 1430, respectively. Respective processors 1490 and 1450 can be associated with memory units (not shown) that store program codes and data. Processors 1490 and 1450 can also perform computations to derive frequency and impulse response estimates for the uplink and downlink, respectively.

For a multiple-access system (e.g., FDMA, OFDMA, CDMA, TDMA, and the like), multiple terminals can transmit concurrently on the uplink. For such a system, the pilot subbands may be shared among different terminals. The channel estimation techniques may be used in cases where the pilot subbands for each terminal span the entire operating band (possibly except for the band edges). Such a pilot subband structure would be desirable to obtain frequency diversity for each terminal. The techniques described herein may be implemented by various means. For example, these techniques may be implemented in hardware, software, or a combination thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof With software, implementation can be through modules (e.g., procedures, functions, and so on) that perform the functions described herein. The software codes may be stored in memory unit and executed by the processors 1490 and 1450.

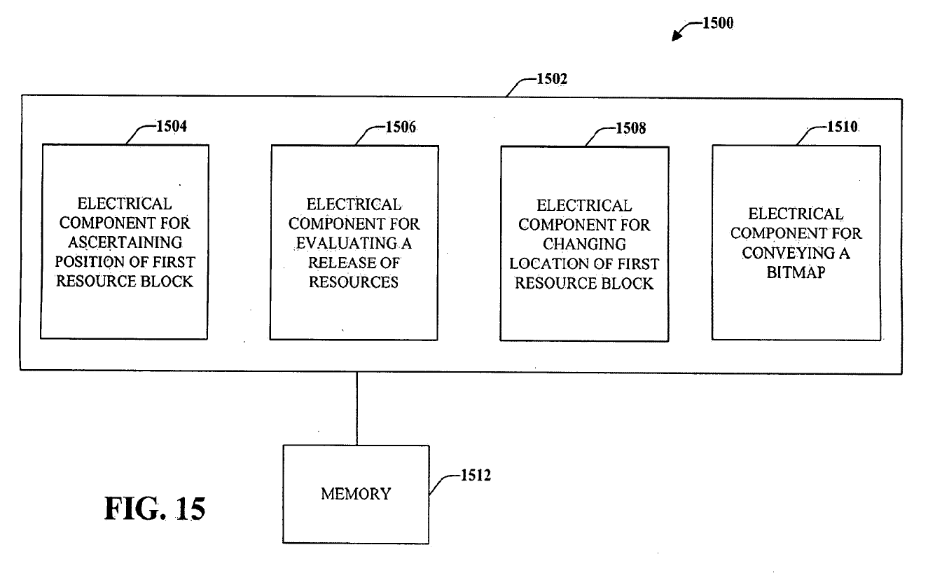

With reference to FIG. 15, illustrated is an example system 1500 that implements synchronous adaptive HARQ. System 1500 may reside at least partially within a base station. It is to be appreciated that system 1500 is represented as including functional blocks, which may be functional blocks that represent functions implemented by a processor, software, or combination thereof (e.g., firmware).

System 1500 includes a logical grouping 1502 of electrical components that can act separately or in conjunction logical grouping 1502 may include an electrical component for ascertaining a position of a first resource block 1504. Also included is an electrical component for evaluating whether there is a release of resources for at least a second resource block 1506. A release of resources can be indicated by a “0” or a “1” included in a location of the second resource block. The “0” indicates a release of resources and the “1” indicates no release of resources. In accordance with some aspects, the release of resources indicates termination of HARQ retransmission and no release of resources indicates continuing HARQ retransmissions.

Logical grouping 1502 also includes an electrical component for changing the position of the first resource block 1508. The position of the first resource block is changed if there is a release of resources for the second resource block. Also included in logical grouping 1502 is an electrical component for conveying a bitmap 1510. The bitmap can include information relating to the changed position. The bitmap can be conveyed to one or more access terminals.

In accordance with some aspects, logical grouping 1502 can include an electrical component for creating the bitmap. The bitmap can include a retransmission offset and a signal that indicates a direction of the retransmission offset. Additionally or alternatively, logical grouping 1502 can include an electrical component for indicating whether new data is to be transmitted or whether the same data should be transmitted in a different format if there is a release of resources. The indication can be a New Data Indicator bit included in an uplink grant.

Additionally, system 1500 can include a memory 1512 that retains

instructions for executing functions associated with electrical components 1504, 1506, 1508, and 1510 or oilier components. While shown as being external to memory 1512, it is to be understood that one or more of electrical components 1504, 1506, 1508, and 1510 may exist within memory 1512.

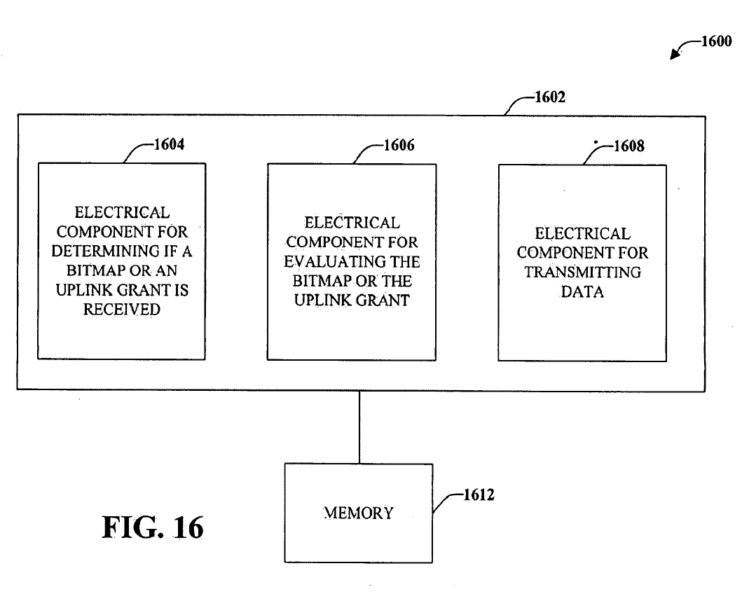

FIG. 16 illustrates an example system 1600 that mitigates resources fragmentation on an uplink transmission. System 1600 may reside at least partially within a mobile device; It is to be appreciated that system 1600 is represented as including functional blocks, which may be functional blocks that represent functions implemented by a processor, software, or combination thereof (e.g., firmware).

System 1600 includes a logical grouping 1602 of electrical components that can act separately or in conjunction. Logical grouping 1602 may include an electrical component for determining if a bitmap is received in place of an uplink grant 1604.

Logical grouping 1604 also includes an electrical component for evaluating the bitmap for a changed position of at least one resource block 1606. Electrical component 1606 can evaluate the bitmap by reviewing a bit within the bitmap, the bitmap indicates a direction in which the position of the at least one resource block was changed. This direction can be a positive direction or a negative direction. The at least one resource block might have been changed to assign resources to a first end of a spectrum.

Also included in logical grouping is an electrical component for transmitting the at least one resource block at the changed position 1608. Electrical component 1608 can further place a “0” or a “1” in the at least one resource block. The “0” can indicate a release of resources and the “1” can indicate no release of resources. In accordance with some aspects, the “0” indicates a positive acknowledgment and the “1” indicates a negative acknowledgement.

In accordance with some aspects, electrical component 1604 can receive an uplink grant if a bitmap is not received and electrical component 1606 evaluates the uplink grant for a New Data Indicator (NDI) bit. If the NDI bit is not set, electrical component 1608 can transmit a first set of data, which can be previously transmitted data that is to be sent in a different format. If the NDI bit is set, electrical component 1608 can transmit a second set of data, which can be new data.

Additionally, system 1600 can include a memory 1610 that retains instructions for executing functions associated with electrical components 1604, 16206, and 1608 or other components. While shown as being external to memory 1610, it is to be understood that one or more of electrical components 1604, 16206, and 1608 may exist within memory 1610.

It is to be understood that the aspects described herein may be implemented by hardware, software, firmware, middleware, microcode, or any combination thereof. When the systems and/or methods are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using, any suitable means including memory sharing, message passing, token passing, network transmission, etc.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the art. Further, at least one processor may include one or more modules operable to perform the functions described herein.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more, devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor; or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA); CDMA2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (LIMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques

While the foregoing disclosure discusses illustrative aspects and/or aspects, it should be noted that various changes and modifications could be made herein without departing from the scope of the described aspects and/or aspects as defined by the appended claims. Accordingly, the described aspects are intended to embrace all such alterations; modifications and variations that fall within scope of the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description of the claims is meant to be a “non-exclusive or”.

What is claimed is:

1. A method for mitigating resource fragmentation, comprising:
deciding if a position of at least one resource block should be changed for an uplink transmission;
assigning the at least one resource block to a changed position;
creating a bitmap to indicate the changed position; and
transmitting the bitmap in place of an uplink grant.

2. The method of claim 1, wherein assigning the at least one resource block to the changed position comprises compacting assigned resources included in the uplink transmission.

3. The method of claim 1, wherein assigning the at least one resource block to the changed position comprises grouping assigned resources toward a first end of a spectrum.

4. The method of claim 1, further comprising:
including a bit in the bitmap that indicates a direction in which the position of the at least one resource block was changed, the direction is a positive direction or a negative direction.

5. The method of claim 1, deciding if the position of the at least one resource block should be changed for the uplink transmission, comprising:
determining if there is a release of resources in a location of a corresponding resource block; and
changing the position of the least one resource block if the determination is that there is a release of resources.

6. The method of claim 5, the release of resources is indicated by a “0”, wherein the “0” indicates a positive acknowledgement.

7. The method of claim 1, deciding if the position of the at least one resource block should be changed for the uplink transmission, comprising:
determining if there is a release of resources in a location of a corresponding resource block; and
retaining the position; of the least one resource block if the determination is that there is no release of resources.

8. The method of claim 7, wherein retaining the position is indicated by a “1”, wherein the “1” indicates a negative acknowledgement.

9. The method of claim 1, further comprising:
transmitting no bitmap if it is decided that the position of the least one resource block should not be changed for the uplink transmission, wherein no bitmap indicates termination of HARQ retransmissions.

10. The method of claim 1, deciding if the position of the at least one resource block should be changed for the uplink transmission, comprising:
determining if a location of a corresponding resource block includes a “0” or a “1”, wherein the “0” indicates termination of HARQ retransmissions on the corresponding resource block and the “1” indicates continuing HARQ retransmissions on the corresponding resource block.

11. The method of claim 10, further comprising indicating in an uplink grant whether new data is to be transmitted or whether existing data should be transmitted in a different format if there is a termination of HARQ retransmissions, wherein the indication in the uplink grant is included in a New Data Indicator bit.

12. A wireless communications apparatus, comprising:
a memory that retains instructions related to determining whether a location of one or more resource blocks should be changed, assigning the one or more resource blocks to a changed location, creating a bitmap that provides information relating to the changed location, and conveying the bitmap to one or more access terminals; and
a processor, coupled to the memory, configured to execute the instructions retained in the memory.

13. The wireless communication apparatus of claim 12, the memory further retains instructions related to including within the bitmap a signal that indicates a direction of the changed location, wherein the direction is a positive direction or a negative direction.

14. The wireless communication apparatus of claim 12, wherein assigning the one or more resource blocks to a changed location comprises grouping the one or more resource blocks toward a first end of a spectrum.

15. The wireless communication apparatus of claim 12, the memory further retains instructions related to determining if there is a release of resources in a location of a corresponding resource block, changing the location of the one or more resource blocks if there is a release of resources, and not changing the location of the one or more resource blocks if there is no release of resources.

16. The wireless communication apparatus of claim 15, wherein a release of resources is indicated by a “0” and no release of resources is indicated by a “1”.

17. The wireless communication apparatus of claim 12, the memory further retains instructions related to determing if a location of a corresponding resource block includes a “0” or a “1”, wherein the “0” indicates termination of HARQ retransmission on the corresponding resource block and a “1” indicates continuing HARQ retransmissions on the corresponding resource block.

18. A wireless communication apparatus that implements synchronous adaptive. HARQ, comprising:
means for ascertaining a position of a first resource block;
means for evaluating whether there is a release of resources for at least a second resource block;
means for changing the position of the first resource block if there is a release of resources; and
means for conveying a bitmap that includes the changed position to one or more access terminals.

19. The wireless communications apparatus of claim 18, wherein a “0” included in a location of the second resource block indicates a release of resources and a “1” included in the location of the second resource block indicates no release of resources.

20. The wireless communications apparatus of claim 19, wherein the release of resources indicates termination of HARQ retransmission and no release of resources indicates continuing HARQ retransmissions.

21. The wireless communications apparatus of claim 18, further comprising means for creating the bitmap, wherein the bitmap includes a retransmission offset and a signal that indicates a direction of the retransmission offset.

22. The wireless communications apparatus of claim 18, further comprising means for indicating whether new data is to be transmitted or whether existing data should be transmitted in a different format if there is a release of resources, wherein the indication is a New Data Indicator bit included in an uplink grant.

23. A computer program product, comprising:
a computer-readable medium comprising:
code for synchronous adaptive HARQ, comprising:
code for deciding whether there is a release of resources in a location of at least one resource block;
code for reassigning at least a second resource block to the location if there is a release of resources;
code for creating a bitmap that comprises the reassignment; and
code for conveying the bitmap to at least one access terminal.

24. The computer program product of claim 23, wherein the bitmap includes a retransmission offset and a signal that indicates a direction with respect to the retransmission offset, wherein the direction is a positive direction or a negative direction.

25. In a wireless communications system, an apparatus comprising: a processor configured to:
decide if a position of at least one resource block should be changed for an uplink transmission;
assign the at least one resource block to a changed position; create a bitmap to indicate the changed position, wherein the changed position is indicated by a retransmission offset and a signaling bit; and transmit the bitmap in place of an uplink grant.

26. A method for mitigating resource fragmentation on an uplink, comprising: determining if the bitmap is received in place of an uplink grant; evaluating the bitmap for a changed position of at least one resource block; and transmitting the at least one resource block at the changed position.

27. The method of claim 26, further comprising:
receiving an uplink grant if a bitmap was not received;
evaluating the uplink grant for a New Data Indicator bit; and
transmitting a first set of data or a second set of data based on information included in the New Data Indicator bit, wherein the first set of data is previously transmitted data and the second set of data is new data.

28. The method of claim 26, wherein the bitmap indicates continuation of HARQ resources or termination of HARQ resources.

29. The method of claim 26, wherein evaluating the bitmap includes reviewing a bit in the bitmap, wherein the bit indicates a direction of the changed position, the direction is a positive direction or a negative direction.

30. The method of claim 26, wherein the changed position groups assigned resources toward a first end of a spectrum.

31. The method of claim 26, transmitting the at least one resource block at the changed position further comprising:
placing a “0” or a “1” in the at least one resource blocks wherein the “0” indicates a release of resources and the “1” indicates no release of resources.

32. The method of claim 31, wherein the “0” indicates a positive acknowledgement and the “1” indicates a negative acknowledgement.

33. A wireless communications apparatus, comprising:
a memory that retains instructions related to determining if a bitmap is received in place of an uplink grant, evaluating the bitmap for a changed position of at least one resource block, and transmitting the at least one resource block at the changed position; and
a processor, coupled to the memory, configured to execute the instructions retained in the memory.

34. The wireless communications apparatus of claim 33, the memory further retains instructions related to receiving an uplink grant if the bitmap was not received, evaluating the uplink grant for a New Data Indicator bit, and transmitting a first set of data or a second set of data based on information included in the New Data Indicator bit, wherein the first set of data is previously transmitted data and the second set of data is new data.

35. The wireless communications apparatus of claim 33, wherein the bitmap indicates continuation of HARQ resources or termination of HARQ resources.

36. The wireless communications apparatus of claim 33, wherein evaluating the bitmap includes reviewing a bit in the bitmap, wherein the bit indicates a direction in which the position of the at least one resource block was changed, the direction is a positive direction or a negative direction.

37. The wireless communications apparatus of claim 33, wherein the changed position groups assigned resources toward a first end of a spectrum.

38. The wireless communications apparatus of claim 33, the memory further retains instructions related to placing a “0” or a “1” in the at least one resource block, wherein the “0” indicates a release of resources and the “1” indicates no release of resources.

39. The wireless communications apparatus of claim 38, wherein the “0” indicates a positive acknowledgement and the “1” indicates a negative acknowledgement.

40. A wireless communication apparatus that mitigates resource fragmentation on an uplink, comprising:
means for determining if a bitmap is received in place of an uplink grant;
means for evaluating the bitmap for a changed position of at least one resource block; and
means for transmitting the at least one resource block at the changed position.

41. The wireless communications apparatus of claim 40, wherein the means for determining receives an uplink grant, the means for evaluating reviews the uplink grant for a New Data Indicator bit, and the means for transmitting sends a first set of data or a second set of data based on information included in the New Data Indicator bit, wherein the first set of data is previously transmitted data and the second set of data is new data.

42. The wireless communications apparatus of claim 40, wherein the bitmap indicates continuation of HARQ resources or termination, of HARQ resources.

43. The wireless communications apparatus of claim 40, wherein the means for evaluating reviews a bit in die bitmap, wherein the bit indicates a direction in which the position of the at least one resource block was changed, the direction is a positive direction or a negative direction.

44. The wireless communications apparatus of claim 40, wherein the changed position groups assigned resources toward a first end of a spectrum.

45. The wireless communications apparatus of claim 40, further comprising: means for placing a “0” or a “1” in the at least one resource block, wherein the “0” indicates a release of resources and the “1” indicates no release of resources.

46. The wireless communications apparatus of claim 45, wherein the “0” indicates a positive acknowledgement and the “1” indicates a negative acknowledgement.

47. A computer program product, comprising;
a computer-readable medium comprising:
code for synchronous adaptive HARQ, comprising:
code for determining if a bitmap is received in place of an uplink grant;
code for evaluating the bitmap for a changed position of at least one resource block; and
code for transmitting the at least one resource block at the changed position.

48. The computer program product of claim 47, further comprising:
code for determining if an uplink grant is received after an indication of termination of HARQ retransmissions;
code for evaluating the uplink grant for a New Data Indicator bit, and
code for transmitting a first set of data or a second set of data based on information included in the New Data Indicator bit, wherein the first set of data is previously transmitted data and the second set of data is new data.

49. In a wireless communications system, an apparatus comprising: a processor configured to:
decide if a bitmap is received in place of an uplink grant;
evaluate the bitmap for a changed position of at least one resource block;
place a “0” or a “1” in the at least one resource block, wherein the “0” indicates a release of resources and the “1” indicates no release of resources; and
transmit the at least one resource block at the changed position.

50. A method, comprising:
receiving a resource block that includes at least one assigned resource that is set to “1”; and
interpreting the “1” as continuing HARQ retransmission, otherwise there is a termination of HARQ retransmission;.

51. The method of claim 50, further comprising:
receiving an uplink grant that includes a New Data Indicator (NDI) bit; determining whether the NDI bit is set or is not set;
transmitting a current set of data on a different resource if the NDI bit is not set; and
transmitting a new set of data if the NDI bit is set.
